(19) United States
(12) Patent Application Publication
(10) Pub. No.: US 2014/0311222 A1
(43) Pub. Date: Oct. 23, 2014

(54) QUICK LEAK DETECTION ON DIMENSIONALLY STABLE/SLACK PACKAGING WITHOUT THE ADDITION OF TEST GAS

(71) Applicant: Inficon GMBH, Köln (DE)

(72) Inventors: Silvio Decker, Koln (DE); Daniel Wetzig, Koln (DE); Hjalmar Bruhns, Bonn (DE); Stefan Mebus, Koln (DE)

(21) Appl. No.: 14/357,973

(22) PCT Filed: Oct. 25, 2012
(86) PCT No.: PCT/EP2012/071133

§ 371 Date: May 13, 2014

(30) Foreign Application Priority Data
Nov. 16, 2011 (DE) 102011086486.5

(51) Int. Cl. G01M 3/02

(52) U.S. Cl. CPC G01M 3/02
USPC 73/40

(57) ABSTRACT

The invention relates to a device for leak detection on a test specimen, having an evacuable test chamber for the test specimen. The test chamber is provided with at least one wall area made of a flexible, in particular elastic material. For more precise leakage detection, the progression of the total pressure increase inside the test chamber is measured.

The invention relates to a device for leak detection on a test specimen.

Conventionally, leaks in a test specimen, e.g. a food package, are measured by placing the test specimen in a rigid test chamber. Thereafter, the test chamber is evacuated and a measurement of the pressure progression in the chamber after the disengagement of the chamber from the pump is performed. If the test specimen has a leak, gas escapes from the test specimen into the chamber, whereby the pressure in the test chamber rises. The pressure increase is measured and serves as an indication to the existence of a leak in the package.

It is one problem of the known leak detection method that the pressure inside the test chamber is not influenced exclusively by a leak in the test specimen, but also by temperature variations in the test chamber or by desorption of gases on inner surfaces of the test chamber, whereby measuring errors occur in leak detection. These disturbing influences are the greater, the larger the volume of the test chamber is and the higher the pressure during the measurement is within the test chamber. For practical reasons, the volume of the test chamber cannot be reduced at will, since the shape, the size and the number of test specimens require a certain chamber volume. Further, it is not possible to reduce the pressure during the measurement in the test chamber at will, since there is a risk of the test specimen being deformed, damaged or even bursting, in particularly with soft, dimensionally instable test specimens such as packages, for example.

Further, test chambers are known in which at least one wall portion and preferably the entire test chamber is made from a flexible, preferably elastically deformable material, such as a film, for example. The flexible wall portion is formed in the region of the chamber where the test specimen is located during leakage measurement. As the pressure inside the test chamber is reduced, the flexible chamber wall clings to the test specimen, whereby the chamber volume is reduced. Thereby, influences interfering with the measurement, in particular pressure variations caused by temperature variations, are reduced. Moreover, the flexible wall portion clinging to the test specimen supports the test specimen and prevents the test specimen from being deformed or from even bursting. This is advantageous in particular with dimensionally instable test specimens, such as packages, for example.

Such film test chambers are described, for example, in JP-A 62-112027, EP 0 152 981 A1 and EP 0 741 288 B1. JP-A 62-112027 describes the detection of the escaping gas by means of a gas detector. EP 0 152 981 A1 describes an evacuation of the film chamber, wherein the pressure difference between the pressure in the film chamber and a reference pressure in a reference volume is observed. If this pressure difference deviates from zero, a leak is considered to have been detected. In EP 0 741 288 B1, a film chamber is pressurized and the pressure is measured at a certain moment for the purpose of leak detection. When a threshold value is exceeded, a leak is considered to have been detected.

It is an object of the present invention to provide a device for leak detection on a test specimen, which allows for quick leak detection.

The device of the present invention is defined by the features of claim 1.

According thereto, leak detection is performed by measuring the total pressure increase of the pressure inside the test chamber. The test for possible leaks is carried out without the aid of test gas. Here, a direct gas exchange between the test chamber and the total pressure sensor is not necessary, so that no gas has to flow from the leak to the pressure sensor.

In this context, total pressure is understood as the absolute pressure within the film test chamber. The term total pressure serves as a means of differentiation over the conventionally known leak detection techniques using the evaluation of a differential pressure. According to the invention, the progression of the total pressure increase is evaluated over the entire measuring interval, i. e. during the entire duration of the measurement. The shape of the pressure increase progression serves for a quick estimation on the existence of a leak. The progression of the pressure increase is more accurate than a mere monitoring of threshold values or a measuring of differential pressures. The quick evaluation of the progression of the total pressure increase enables a fully automated and particularly quick measuring cycle for implementation in fully automated leak detection operations.

Preferably, the test chamber is made of one or a plurality of flexible films, into or between which the test specimen is positioned. The film or the films may be connected and closed by means of clamping elements, such as clips, for example.

A gas-permeable material or a gas-permeable structure at an inner wall portion of the test chamber in the region of the test specimen allows for a gas flow around the test specimen, even after the flexible test chamber wall clings to the test specimen, whereby it is possible to evacuate the entire chamber volume further to a low total pressure.

Preferably, the pressure progression, i.e. the progression of the total pressure and, possibly, also the progression of the partial pressure of individual gas components is evaluated already during the pump-off phase of the measuring sequence, so as to allow for coarse leak detection.

It is advantageous if the test chamber is enclosed by an outer overpressure chamber. For a preliminary removal of gas from the test chamber, it is possible to increase the pressure in the outer chamber relative to the pressure in the test chamber so that an external force acts on the flexible test chamber and the flexible region of the test chamber is caused to cling to the product. Thereby, a large part of the gas is expelled from the test chamber irrespective of the suction capacity of the pump employed. Thereby, the measuring cycle is much faster.

Preferably, a selectively gas-binding material is introduced as an absorber into the chamber or into a volume connected with the test chamber volume. The absorber material binds reactive gas that influences the pressure increase in the chamber by desorption and which could compromise the leakage rate measurement. The desorption of gases at the surfaces of the test chamber inner sides typically causes an additional increase in pressure and results in measuring errors in leakage rate measurement. Specifically, water in a pressure range of less than 10 mbar makes a major contribution to the total pressure increase by desorption. In total pressure measurement, the pressure increase in the test chamber caused by water cannot be differentiated from a pressure increase caused by a leak in the test specimen. The absorber material can reduce this measuring error.

Preferably, the absorber material is accommodated in a connecting channel between the test chamber and a pressure sensor, for example the total pressure sensor. In this case, the volume within the connecting channel, in which the absorber material is situated, should be adapted to be separated from the test chamber volume by a shut-off valve. During ventilation and during the pump-off phase, e.g. for coarse leak detection, when the valve is closed, the absorber material is not exposed to atmospheric gas and the capacity of the absorber material for selective gas binding is preserved.

The following is a detailed description of embodiments of the invention with reference to the Figures. In the Figures:

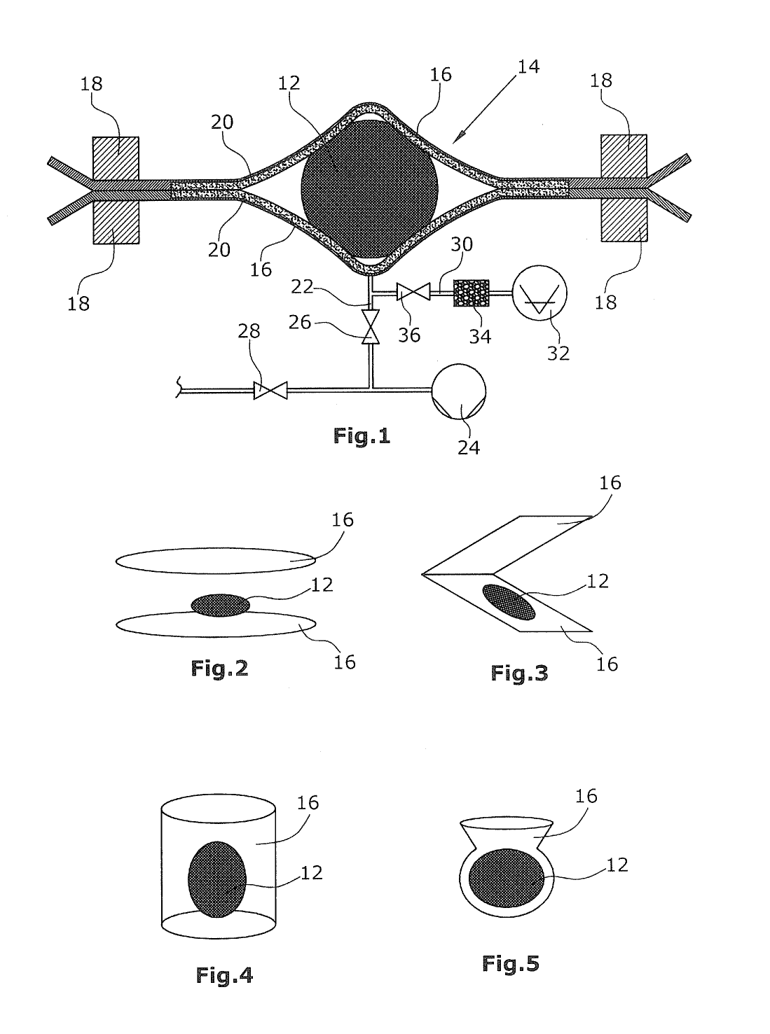

FIG. 1 shows a first embodiment,

FIG. 2 is a schematic illustration of the test chamber of the first embodiment in the open state,

FIG. 3 shows a second embodiment in a view similar to FIG. 2,

FIG. 4 shows a third embodiment in a view similar to FIG. 2,

FIG. 5 shows a fourth embodiment in a view similar to FIG. 2,

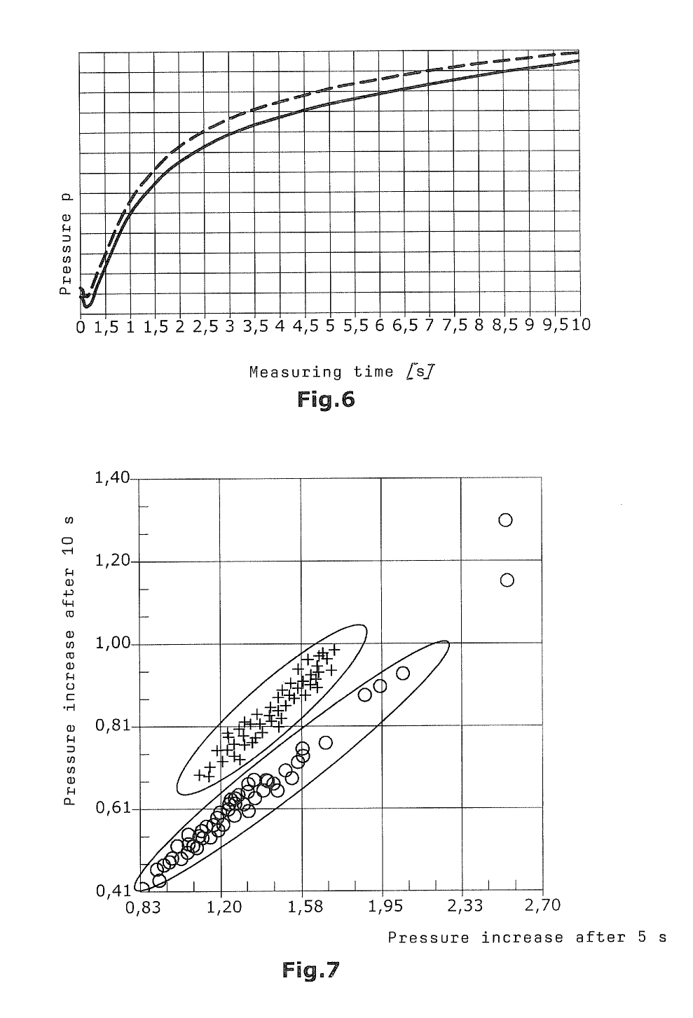

FIG. 6 shows an exemplary progression of the measured pressure and

FIG. 7 shows an example for an evaluation of the pressure increase at fixed times.

The test specimen 12 is placed in the chamber 14. Then, the chamber 14 is closed and is evacuated via a valve 26. Owing to the pressure drop in the chamber 14 and the accompanying external force exerted by atmospheric pressure, the flexible chamber wall 16 clings to the entire test specimen 12 and adapts to the outer shape thereof.

A gas permeable material of a nonwoven fabric 20 is provided between the chamber foil 16 and the test specimen 12. As an alternative, the surface of the films 16 can be structured. This enables a gas flow around the test specimen 12 also after the film chamber 14 clings to the test specimen 12, and thus enables further evacuation of the entire chamber volume to a low total pressure.

A vacuum is generated between the film 16 and the test specimen 12, typically in the range from 1 to 50 mbar absolute pressure, corresponding to the chamber pressure of a rigid test chamber. Despite the vacuum around the package 12, no force is effectively exerted on the same, since the internal pressure of the test specimen 12 and the external pressure on the flexible chamber material are identical. Thus, the film 16 uniformly supports the package on all sides and prevents the same from distending or from being destroyed.

The intermediate space filled with nonwoven 20 forms the free volume which typically has a size of only a few cm³. Due to the film chamber's 14 adaptation to the shape of the test specimen 12, a minimum chamber volume is reached even when different test specimens are used.

A leak in the test specimen 12 leads to a continuous total pressure increase in the film chamber 14 after the same has been separated from the pump 24 by means of the valve 26. This total pressure is determined by total pressure measurement using a sensitive total pressure measuring device (vacuum meter).

The pressure progression during the accumulation phase is evaluated and is compared with set values. If a corresponding deviation from set values occurs, a leak in the test specimen 12 is detected.

$$\begin{matrix}\frac{Δ {p}_{chamber}}{Δ t} = \frac{{q}_{p}}{{V}_{chamber}} & ( 1 ) \\ {q}_{p} ∝ {( \frac{{P}_{test specimen}}{{P}_{chamber}} )}^{2} & ( 2 )\end{matrix}$$

$$\frac{Δ {p}_{chamber}}{Δ t} \text{:}$$

pressure variation Δp_{chamber} in the test chamber per time period Δt
V_{chamber}: chamber volume [l]
qₚ: leakage rate [mbar l/s]
p_{chamber} pₜₑₛₜ specimen: pressure in chamber or test specimen, resp., [mbar]

Both the total pressure increase and the partial pressure increase in the measuring chamber depend on two values: the prevailing chamber pressure and the measuring volume.

A total pressure measurement has two advantages over a test gas detection of a test gas introduced into a package, which advantages will be explained below:
first, there is no dependence on the type of gas, i.e. no special test gas has to be supplied to the product for leak detection,
second, a total pressure variation can be detected immediately anywhere in the test volume. Owing to the principles involved, a sensor system specific to a certain test gas has a diffusion-dependent response time, since the test gas to be detected has to get from the leak to the sensor in order to be detected. Depending on the distance and the total pressure, the diffusion time may be inacceptable for the cycle times intended.

Because of these connections, it is feasible to measure the pressure increase in a very small, free chamber volume, at low chamber pressure and without test gas.

The measuring error caused by temperature variations:

The lower the total pressure in the test chamber is, the higher is the leakage rate from the test specimen and thus the pressure increase to be expected. Further, the total pressure in the test chamber depends on the mean temperature T_{chamber} of the gas. In a first approximation, the following is valid:

$${P}_{chamber} = \frac{R \cdot {T}_{chamber}}{{V}_{chamber}} \qquad ( 3 )$$

Through an error estimation, the following result is obtained therefrom:

$$\vert Δ {p}_{chamber} \vert = \vert {p}_{chamber} \cdot \frac{Δ {T}_{chamber}}{{T}_{chamber}} \vert + \vert {p}_{chamber} \cdot \frac{Δ {V}_{chamber}}{{V}_{cham ber}} \vert \qquad ( 4 )$$

|Δp_{chamber}| is the variation of the pressure due to variations of the temperature and the chamber volume. The pressure variation cannot be differentiated from a pressure variation caused by leaks in the test specimen. The pressure variation |Δp_{chamber}| caused by a temperature variation is proportional to the chamber pressure P_{chamber}. The lower the chamber pressure, the smaller this disturbing influence.

### EXAMPLE At a chamber pressure of 700 mbar, a temperature variation by 0.1 K at a chamber temperature of 25° C. (298.15 K) causes a pressure variation of

$$\vert Δ {p}_{chamber} \vert = 700 mbar \cdot \frac{0 , 1}{298 , 15} \frac{K}{K} = 0.234 mbar \qquad ( 5 )$$

For comparison: Given a measuring time of 10 s and a free chamber volume of 0.1 l, a leakage of q=1×10⁻³ mbar l/s leads to a pressure increase of:

$$\vert Δ {p}_{chamber} \vert = \frac{{q}_{p} \cdot Δ t}{{V}_{chamber}} = \frac{1 \times {10}^{- 3} \frac{mbar \cdot l}{s} \cdot 10 [ s ]}{0 , 1 l} = 0.1 mbar \qquad ( 6 )$$

In this case, the pressure increase caused by temperature variation would be twice the increase caused by the leakage. If one would operate at 7 mbar instead, the pressure variation caused by the temperature variation would only be 0.01 mbar which corresponds to a proportion of merely ˜5% of still the same measuring signal. That is, the same leak that is masked by the temperature variation at 700 mbar total pressure can be measured at 7 mbar. The thermal expansion caused by a temperature drift and the accompanying change in the chamber volume is negligible relative to the direct influence of a temperature variation on the chamber pressure.

Temperature variations can be expected during leak measurement, since, on the one hand, the pressure variation and the accompanying compression/expansion of the gas cause temperature variations and, on the other hand, the test specimens often have a temperature differing from that of the measuring chamber.

The influence of the volume on the measurement:

The pressure variation caused by leaks in the test specimen is the greater, the smaller the free chamber volume—and thus the measuring volume—is. In this context, the free chamber volume is the volume which in the evacuated state of the chamber is not occupied by the test specimen.

### EXAMPLE

In a typical chamber with a free volume of one liter, a leak of the size q=1×10⁻³ mbar l/s causes a pressure increase of ca. 0.01 mbar during 10 s. With a free chamber volume of 10 cm³, the same is about 1 mbar.

### Desorption:

The desorption of, for instance, water also influences the total pressure in the test chamber. With consideration to desorption, the following connection is determined for the total pressure increase within the test chamber:

$$\frac{d p}{d t} = \frac{d {p}_{L}}{d t} + \frac{d {p}_{T}}{d t} + \frac{d {p}_{D}}{d t}$$

$$\frac{d {p}_{L}}{d t} = \frac{{q}_{L}}{{V}_{R}}$$

$$\frac{d {p}_{D}}{d t} = \frac{{A}_{R}}{{V}_{R}} \cdot {q}_{A}$$

$$\frac{d p}{d t} \text{:}$$

total pressure increase [mbar/s]

$$\frac{d {p}_{L}}{d t} \text{:}$$

total pressure increase caused by leak [mbar/s]

$$\frac{d {p}_{T}}{d t} \text{:}$$

total pressure variation caused by temperature drift [mbar/s]

$$\frac{d {p}_{D}}{d t} \text{:}$$

total pressure increase caused by desorption
V_{R}: volume of recipient [l]
A_{R}: surface area of recipient+test specimen [cm²]
q_{L}: leakage rate of test specimen [mbar l/s]
q_{A}: desorption rate of chamber/test specimen [(mbar l)/(s cm²)]

For a sensitive leakage rate measurement over the temporal progression of the total pressure in an accumulation chamber, a minimum possible chamber volume should be aimed at. The smaller the chamber volume, the faster the total pressure rises for a given fixed leakage rate.

In order to achieve the smallest possible total pressure increase caused by desorption in a chamber, a large ratio of volume to surface area should be aimed at. The larger the chamber volume is for a given surface area, the lower the total pressure increase is per unit time.

This forms a contradiction. This contradiction may be resolved by removing the influence of the partial pressure of water by providing an absorber material preferably in a connecting channel between the test chamber and the total pressure measuring device.

The special feature of the invention is that a chamber of a formable and flexible, e.g. elastic material is used, with the total pressure increase in such a sealed chamber being used to measure the leakage. The measuring of the total pressure is effected by measuring the active force per surface area, e.g. using a capacitive total pressure sensor. Here, a test for possible leaks is performed without the aid of test gas. Further, a direct gas exchange between the film chamber and the total pressure sensor is not required. Thus, the gas does not have to flow from the leak to the total pressure sensor.

The test chamber itself may be constituted by a single film or a plurality of films. The special feature of this measuring method is that the contradiction between the smallest volume and the lowest working pressure is resolved while simultaneously protecting the test specimen. Further, owing to the detection by means of the total pressure measurement, no supply of gas from the leak to the sensor is required.

Summarizing, the following problems are solved thereby:
The contradiction between a low working pressure and a simultaneous protection of the test specimen is resolved.
The low working pressure that can be reached significantly reduces the temperature drift and increases the measurable leakage rate.
Owing to the small volume, the pressure increase in the chamber caused by a leak becomes maximal and so does the measuring signal.
Due to the self-minimizing volume, the chamber is evacuated much faster.
No gas flow has to exist between the leak and the total pressure sensor.

As illustrated in FIG. 1, a test specimen 12 in the form of a soft food package is placed into a test chamber 14 formed by a film 16. As illustrated in FIG. 2, the film 16 is formed by two separate film sections between which the test specimen 12 is laid so that the test specimen 12 is entirely enclosed by the two film sections.

FIG. 1 shows that the superimposed edge portions of the two film sections are pressed onto each other by means of clips 18 so that no gas can escape out of the test chamber 14 from between the film sections.

On the inner side of the film 16, a layer of nonwoven is provided that encloses the test specimen 12 and enables a gas flow between the test specimen 12 and the film 16, in order to be able to achieve a complete evacuation of the test chamber 14 even when the film 16 clings tightly to the test specimen 12.

The test chamber 14 is connected to a vacuum pump 24 through a connecting channel 22. A shut-off valve 26 is situated in the connecting channel 22 between the vacuum pump 24 and the test chamber 14, the valve serving to separate the test chamber volume from the vacuum pump 24. Between the shut-off valve 26 and the vacuum pump 24, a ventilation valve 28 is provided for ventilating the test chamber 14.

From the connecting channel 22, a further connecting channel 30 branches off between the test chamber 14 and the shut-off valve 26, which connects the test chamber volume with the pressure sensor of a total pressure measuring device 32. An absorber 34 is provided in the connecting channel 30 and a shut-off valve 36 is provided between the absorber 34 and the test chamber 14. When the shut-off valve 36 is open, the absorber material of the absorber 34 is connected with the test chamber volume. The absorber material preferably is water-absorbing zeolith, so as to reduce the effect of water desorption at the inner wall regions of the test chamber 14. Upon evacuation of the test chamber 14 and/or upon ventilation of the test chamber 14, the shut-off valve 36 is closed in order to preserve the absorption capacity of the absorber 34.

FIG. 3 illustrates an embodiment in which the test chamber 14 is formed by a folded film. The test chamber 14 is closed by folding the film 16 around the test specimen 12.

In the embodiment in FIG. 4, the film 16 is a hose that is closed at its opposite ends in order to form the test chamber 14.

In the embodiment in FIG. 5, the test chamber 14 is formed by a film 16 shaped in the manner of a sack-like balloon which holds the test specimen 12. The open end of the balloon can be closed, for example, by means of clips 18, as illustrated in FIG. 1, to close the test chamber 14.

FIG. 6 shows two curves of a pressure progression in the film chamber during a measuring interval of 10 s. Here, the dash-line curve is that of a tight test specimen, while the continuous curve represents that of a leaky test specimen. As illustrated in FIG. 6, the pressure increase can be larger for tight test specimens than for leaky test specimens over the entire measuring interval. Further, the pressure increase at a certain moment, i.e. the first derivation of the pressure progression with respect to time, can be larger for tight test specimens than for leaky ones. The reason for this is a difference in the degree of gas desorption from the film material and from the nonwoven, respectively. Under these preconditions it is possible that a single value, e.g. the pressure increase or the total pressure difference between the start and the end of the measuring interval, does not provide a clear reference for tight and leaky test specimens. This problem can be solved by a pattern recognition that refers to various curve properties such as the slope or the curvature at defined times, for example.

In FIG. 7, values for the pressure increase after 10 s (end of measuring interval) and for the pressure increase after 5 s (half the measuring interval) are plotted. On the x-axis, the pressure increase values after half the measuring interval (5 s) are shown, and the pressure increase values at the end of the measuring interval (10 s) are plotted on the y-axis. A pattern recognition is used to detect groups of measuring values. Here, a first group is detected for the measuring values of the leaky test specimen, illustrated as crosses, and a second group is detected for the measuring values of the tight test specimen, illustrated as dots. The dashed line in FIG. 7 represents the values of a test specimen classified as leaky. For an allocation or a classification of tight and leaky test specimens, mathematical methods of pattern recognition can be reverted to, such as, for example, LDA (Linear Discriminant Analysis).

1. A device for leak detection on a test specimen, having an evacuable test chamber for the test specimen,
the test chamber being provided with at least one wall area made of a flexible, in particular elastic material,
wherein
the device comprises a measuring means to determine the progression of the total pressure increase inside the test chamber.

2. The device of claim 1, wherein the means for determining the total pressure increase comprises a capacitive total pressure sensor.

3. The device of claim 1, wherein the means is configured to determine the pressure progression during the pump-off phase of the test chamber.

4. The device of claim 1, wherein the test chamber is contained in an outer chamber adapted to be pressurized with overpressure.

5. The device of claim 1, wherein a gas-binding absorber material, in particular zeolith, is provided in the test chamber or in a volume connected with the test chamber.

6. The device of claim 5, wherein the absorber material is contained in a connecting channel between the test chamber and a pressure sensor.

7. The device of claim 6, wherein a shut-off valve is provided in the connecting channel between the absorber and the test chamber volume, the valve being provided for the selective separation of the absorber material from the test chamber volume.

8. A method for leak detection on a test specimen with the use of an evacuable film chamber as the test chamber having at least one wall area of a flexible, in particular elastic material, wherein the progression of the total pressure increase inside the test chamber is measured.

9. The method of claim 8, wherein the existence of a leak is detected from the progression of the total pressure increase over the entire measuring interval.

10. The method of claim 8, wherein, for a detection of a leak, a pattern recognition is performed on the pressure progression increase over the measuring interval.

11. The method of claim 8, wherein the progression of the pressure increase is determined at defined, predetermined times.
